(19) United States
(12) Patent Application Publication
(10) Pub. No.: US 2008/0187666 A1
(43) Pub. Date: Aug. 7, 2008

(54) PROCESS FOR PRINTING TEXTILE FIBRE MATERIALS IN ACCORDANCE WITH THE INK-JET PRINTING PROCESS

(75) Inventor: Marc Burglin, Baldersheim (FR)

Correspondence Address: Legal Department;Huntsman Corporation, 10003 Woodloch Forest Drive, The Woodlands, TX, 77380, US

(73) Assignee: Huntsman International LLC, The Woodlands, TX (US)

(21) Appl. No.: 12/100,257

(22) Filed: Apr. 9, 2008

Related U.S. Application Data
(63) Continuation of application No. 10/573,849, filed on Jun. 19, 2006.

(30) Foreign Application Priority Data
Oct. 15, 2003 (EP) 03103806.0
May 25, 2004 (EP) 04102285.6

(51) Int. Cl. B05D 5/06; C09D 11/02

(52) U.S. Cl. 427/288; 106/31.51; 106/31.48; 106/31.5

(57) ABSTRACT

An ink-jet printing process for printing textile fibre materials, wherein the fiber materials are printed with an aqueous ink that includes at least one disperse dye, and glycerol. The aqueous ink is applied to the fiber material with an ink-jet print head that includes an ink supply layer that receives ink from an external ink reservoir. The ink supply layer has a first side and a second side and includes a porous medium having a plurality of pores therein and a plurality of holes extending there through, so as to allow passage of the ink. The process allows for high speed printing and yields prints with good fastness properties.

This application is a continuation application of U.S. patent application Ser. No. 10/573,849, filed Jun. 19, 2006, which was the National Phase of International Application PCT/EP04/052451 filed Oct. 6, 2004 which designated the U.S. and which claimed priority to European (EP) Pat. App. Nos. 03103806.0 filed Oct. 15, 2003 and 04102285.6 filed May 25, 2004. The noted applications are incorporated herein by reference.

The present invention relates to a process for printing textile fibre materials using disperse dyes in accordance with the ink-jet printing process and to corresponding printing inks.

Rotary and flat-screen printing are presently prevailing as textile printing methods. However, these conventional methods are not profitable unless the quantity of the product is sufficiently large. In addition, since the fashion of the print pattern changes rapidly, there is a risk in that a large quantity of the printed products are not sold but kept in stock when production cannot follow the rapid change in the fashion. Accordingly, there is a demand for establishing electronic textile printing systems, such as ink-jet, that require no printing plates and are suited for multi-item and small-quantity production and respond to fashion rapidly.

Ink-jet printing technology opens up new design capabilities around colors, patterns and images. The ability to change colors and designs quickly is one of the major advantages of ink-jet printing over rotary traditional screen-printing methods. In a digital system, design changes are enabled through software, without needing to engrave screens. Color changes are also made at the computer, eliminating the process of cleaning screens and changing inks. Actual fabric samples of new designs are possible at a fraction of the cost and in a fraction of the time formerly needed. By this way designers and textile and apparel companies can interact to bring new products to market almost instantaneously. Instantaneous data transfer over the global Internet and similar data exchange via local area networks (LANs) make it possible to exchange ideas faster than ever.

Despite the many advantages, ink-jet still suffers from some drawbacks, some of which become even more pronounced when print speed is increasing. Hardware reliability (e.g. clogged nozzles) and speed limitations are technical barriers limiting the use of ink-jet printing primarily to generation of samples. State of the art ink-jet textile printers are capable of printing 2 to 30 m²/h operating at a frequency of 2 to 8 KHz. In order to become a true production method both for short runs and for sampling, ink-jet processes are required which are reliable even at high print speed (e.g. >200 m²/h). However, when printing at high speed, the response to high frequency is liable to be impaired and the ink tends to be unstable depending on the physical property of the ink, owing to the fact that the ink has to be discharged through minute nozzles at high velocity and at high frequency. Furthermore, the quality of the print tends to be impaired due to blotting on the cloth, partly because the ink jet printer does not allow the use of an ink having high viscosity and partly because cloth usually has rougher texture than paper, thus making it difficult to print patterns of minute or delicate design.

Accordingly there is a need for ink-jet printing processes which can be conducted with high reliability, even when running at a high print speed, with an appreciable resolution and which have optimum characteristics from the standpoint of application technology. In this connection the properties of the inks used, such as the viscosity, stability, surface-tension and conductivity, play a decisive role. Furthermore, high demands are being made in terms of the quality of the resulting prints, e.g. in respect of colour strength, fibre-dye bond stability and fastness to wetting. Those demands are not met by the known processes in all characteristics, so that there is still a need for new processes for the ink-jet printing of textiles.

The invention relates to an ink-jet printing process for printing textile fibre materials, wherein the fiber materials are printed with an aqueous ink comprising

(I) at least one disperse dye, and
(II) glycerol,
said ink having a viscosity of from 5 to 20 mPa s at 25° C., and wherein
said ink is applied to the fiber material with an ink-jet print head comprising
an ink supply layer (b) receiving ink from an external ink reservoir, said ink supply layer having a first side and a second side and comprising, a porous medium having a plurality of pores therein and a plurality of holes extending therethrough, so as to allow passage of the ink.

The inks preferably have a total content of dyes of from 1 to 35% by weight, preferably from 1 to 20% by weight, especially from 1 to 15% by weight and more especially from 1 to 10% by weight based on the total weight of the ink. As a lower limit, a limit of 1.2% by weight, preferably 1.5% by weight and especially 2% by weight is preferred.

Suitable disperse dyes for the process of the invention are those described under “Disperse Dyes” in the Colour Index, 3rd edition (3rd Revision 1987 including additions and amendments up to No. 85). Examples are carboxyl- and/or sulfo-free nitro, amino, amino ketone, ketone imine, methine, polymethine, diphenylamine, quinoline, benzimidazole, xanthene, oxazine or coumarin dyes, and especially anthraquinone dyes and azo dyes, such as monoazo or disazo dyes.

As the disperse dyes there come into consideration, for example, dyes of the formula

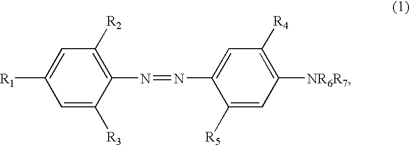

in which
R₁ is halogen, nitro or cyano,
R₂ is hydrogen, halogen, nitro or cyano,
R₃ is hydrogen, halogen or cyano,
R₄ is hydrogen, halogen, C₁-C₄alkyl or C₁-C₄alkoxy,
R₅ is hydrogen, halogen or C₂-C₄alkanoylamino, and
R₆ and R₇ independently of one another are hydrogen, allyl, C₁-C₄alkyl which is unsubstituted or substituted by hydroxy, cyano, C₁-C₄alkoxy, C₁-C₄alkoxy-C₁-C₄alkoxy, C₂-C₄alkanoyloxy, C₁-C₄alkoxycarbonyl, phenyl or phenoxy,

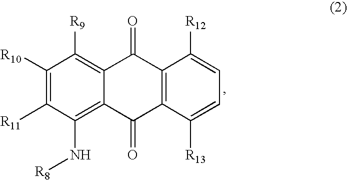

in which
R₈ is hydrogen, C₁-C₄alkyl, phenyl or phenylsulfonyl, the benzene ring in phenyl and phenylsulfonyl being unsubstituted or substituted by C₁-C₄alkyl, sulfo or C₁-C₄alkyl-sulfonyloxy,
R₉ is hydroxy, amino, N-mono- or N,N-di-C₁-C₄alkylamino, phenylamino, the benzene ring in phenyl being unsubstituted or substituted by C₁-C₄alkyl, C₁-C₄alkoxy, C₂-C₄alkanoylamino or halogen,
R₁₀ is hydrogen, C₁-C₄alkoxy or cyano,
R₁₁ is hydrogen, C₁-C₄alkoxy, phenoxy or the radical —O—C₆H₅—SO₂—NH—(CH₂)₃—O—C₂H₅,
R₁₂ is hydrogen, hydroxy or nitro, and
R₁₃ is hydrogen, hydroxy or nitro,

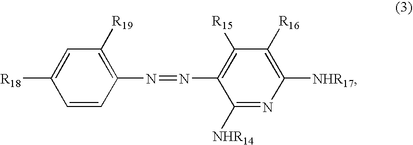

in which
R₁₄ is C₁-C₄alkyl which is unsubstituted or substituted by hydroxy,
R₁₅ is C₁-C₄alkyl,
R₁₆ is cyano,
R₁₇ is the radical of the formula —(CH₂)₃—O—(CH₂)₂—O—C₆H₅,
R₁₈ is halogen, nitro or cyano, and
R₁₉ is hydrogen, halogen, nitro or cyano,

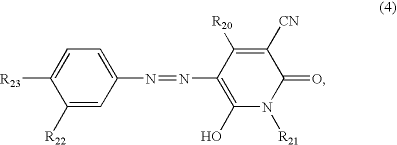

in which
R₂₀ is C₁-C₄alkyl,
R₂₁ is C₁-C₄alkyl which is unsubstituted or substituted by C₁-C₄alkoxy and
R₂₂ is the radical —COOCH₂CH₂OC₆H₅ und R₂₃ is hydrogen or
R₂₂ is hydrogen and R₂₃ is the radical —N═N—C₆H₅,

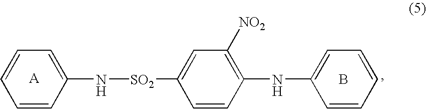

where the rings A and B are unsubstituted or substituted one or more times by halogen,

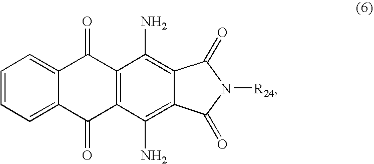

in which
R₂₄ is C₁-C₄alkyl, which is unsubstituted or substituted by hydroxy, C₁-C₄alkoxy, C₁-C₄-alkoxy-C₁-C₄alkoxy, C₂-C₄alkanoyloxy or C₁-C₄alkoxycarbonyl,

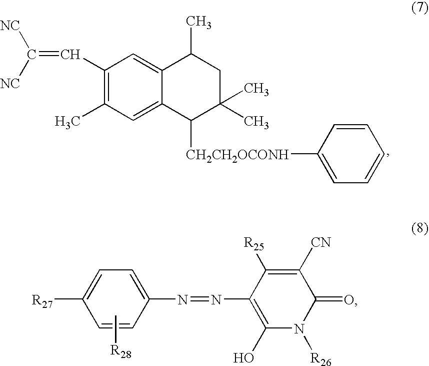

in which
R₂₅ is C₁-C₄alkyl,
R₂₆ is C₁-C₄alkyl, which is unsubstituted or substituted by C₁-C₄alkoxy,
R₂₇ is hydrogen, C₁-C₄alkoxy or halogen, and
R₂₈ is hydrogen, nitro, halogen or phenylsulfonyloxy,

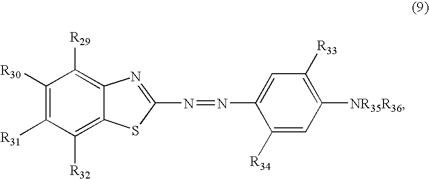

in which
R₂₉, R₃₀, R₃₁ and R₃₂ independently of one another are hydrogen or halogen,
R₃₃ is hydrogen, halogen, C₁-C₄alkyl or C₁-C₄alkoxy,
R₃₄ is hydrogen, halogen or C₂-C₄alkanoylamino, and
R₃₅ and R₃₆ independently of one another are hydrogen, C₁-C₄alkyl, which is unsubstituted or substituted by hydroxy, cyano, acetoxy or phenoxy,

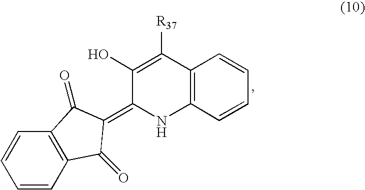

in which
R₃₇ is hydrogen or halogen,

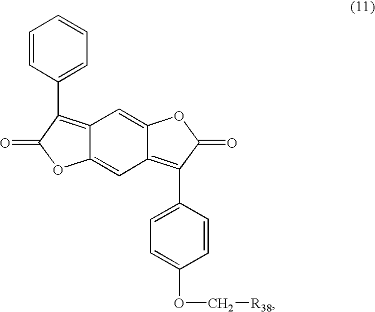

in which
R₃₈ is hydrogen, C₁-C₄alkyl, tetrahydrofuran-2-yl or C₁-C₄alkoxycarbonyl, which is unsubstituted or substituted in the alkyl by C₁-C₄alkoxy,

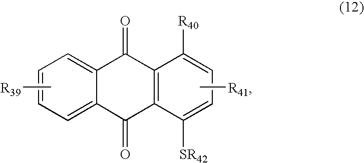

in which
R₃₉ is hydrogen or thiophenyl, which is unsubstituted or substituted in the phenyl by C₁-C₄-alkyl or C₁-C₄-alkoxy,
R₄₀ is hydrogen, hydroxy or amino,
R₄₁ is hydrogen, halogen, cyano or thiophenyl, which is unsubstituted or substituted in the phenyl by C₁-C₄alkyl or C₁-C₄-alkoxy, phenoxy or phenyl, and
R₄₂ is phenyl, which is unsubstituted or substituted by halogen, C₁-C₄alkyl or C₁-C₄-alkoxy,

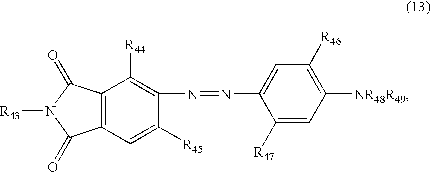

in which
R₄₃ is hydrogen or C₁-C₄alkyl,
R₄₄ and R₄₅ independently of one another are hydrogen, halogen, nitro or cyano,
R₄₆ is hydrogen, halogen, C₁-C₄alkyl or C₁-C₄alkoxy,
R₄₇ is hydrogen, halogen or C₂-C₄alkanoylamino, and
R₄₈ and R₄₉ independently of one another are hydrogen or C₁-C₄alkyl, which is unsubstituted or substituted by hydroxy, cyano, C₁-C₄alkoxy, C₁-C₄alkoxy-C₁-C₄alkoxy, C₂-C₄alkanoyloxy, C₁-C₄alkoxycarbonyl, phenyl or phenoxy.

As C₁-C₄alkyl radicals there come into consideration, for example, methyl, ethyl, n-propyl, isopropyl, n-butyl, sec-butyl, tert-butyl and isobutyl, preferably methyl and ethyl.

As C₁-C₄alkoxy radicals there come into consideration, for example, methoxy, ethoxy, n-propoxy, isopropoxy, n-butoxy, sec-butoxy, tert-butoxy and isobutoxy, preferably methoxy and ethoxy, and especially methoxy.

As halogen there come into consideration, for example, fluorine, chlorine, bromine and iodine, preferably chlorine and bromine, and especially chlorine.

As C₂-C₄alkanoylamino radicals there come into consideration, for example, acetylamino and propionylamino, especially acetylamino.

As C₁-C₄alkoxy-C₁-C₄alkoxy radicals there come into consideration, for example, methoxy-methoxy, methoxy-ethoxy, ethoxy-methoxy, ethoxy-ethoxy, ethoxy-n-propoxy, n-propoxy-methoxy, n-propoxy-ethoxy, ethoxy-n-butoxy and ethoxy-isopropoxy, preferably ethoxy-methoxy and ethoxy-ethoxy.

As N-mono- or N,N-di-C₁-C₄alkylamino radicals there come into consideration, for example, N-methylamino, N-ethylamino, N-propylamino, N-isopropylamino, N-butylamino, N-sec-butylamino, N-isobutylamino, N,N-dimethylamino and N,N-diethylamino, preferably N-isopropylamino.

As C₂-C₄alkanoyloxy radicals there come into consideration, for example, acetyloxy and propionyloxy, preferably acetyloxy.

As C₁-C₄alkoxycarbonyl radicals there come into consideration, for example, methoxycarbonyl, ethoxycarbonyl, n-propoxycarbonyl, isopropoxycarbonyl and n-butoxycarbonyl, preferably methoxycarbonyl and ethoxycarbonyl.

As C₁-C₄alkylsulfonyloxy radicals there come into consideration, for example, methylsulfonyloxy, ethylsulfonyloxy, n-propylsulfonyloxy, isopropylsulfonyloxy and n-butylsulfonyloxy, preferably methylsulfonyloxy and ethylsulfonyloxy.

In the process of the invention, preference is given to using the dyes of the formulae

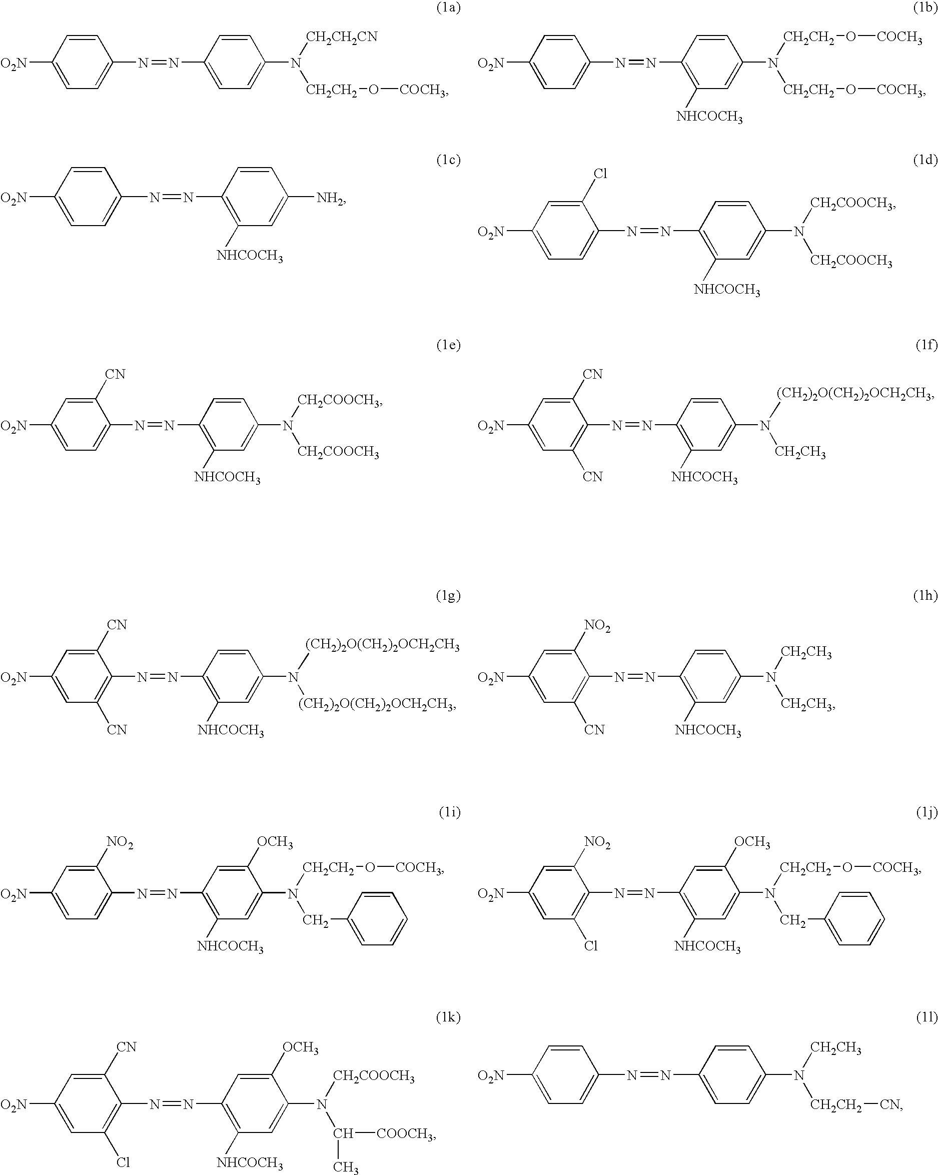

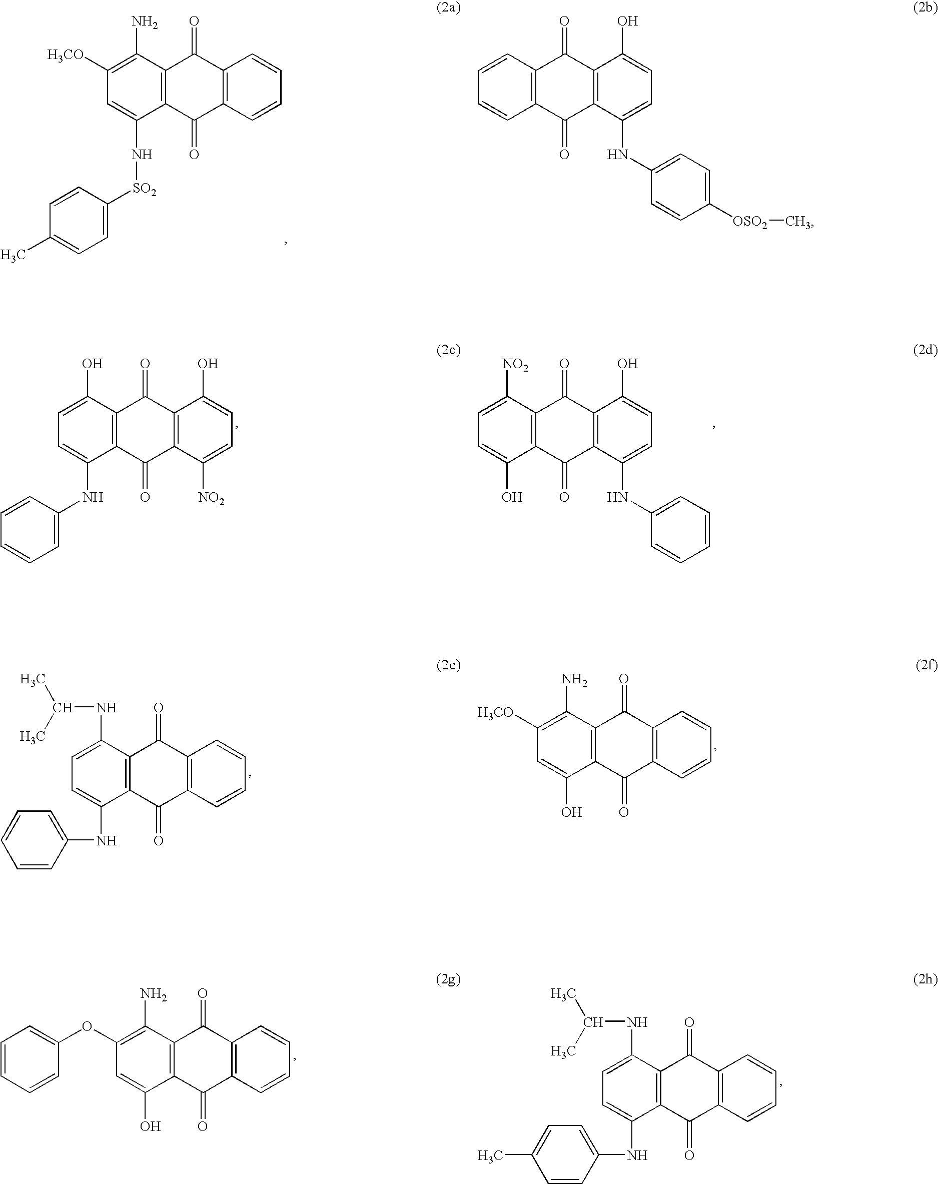

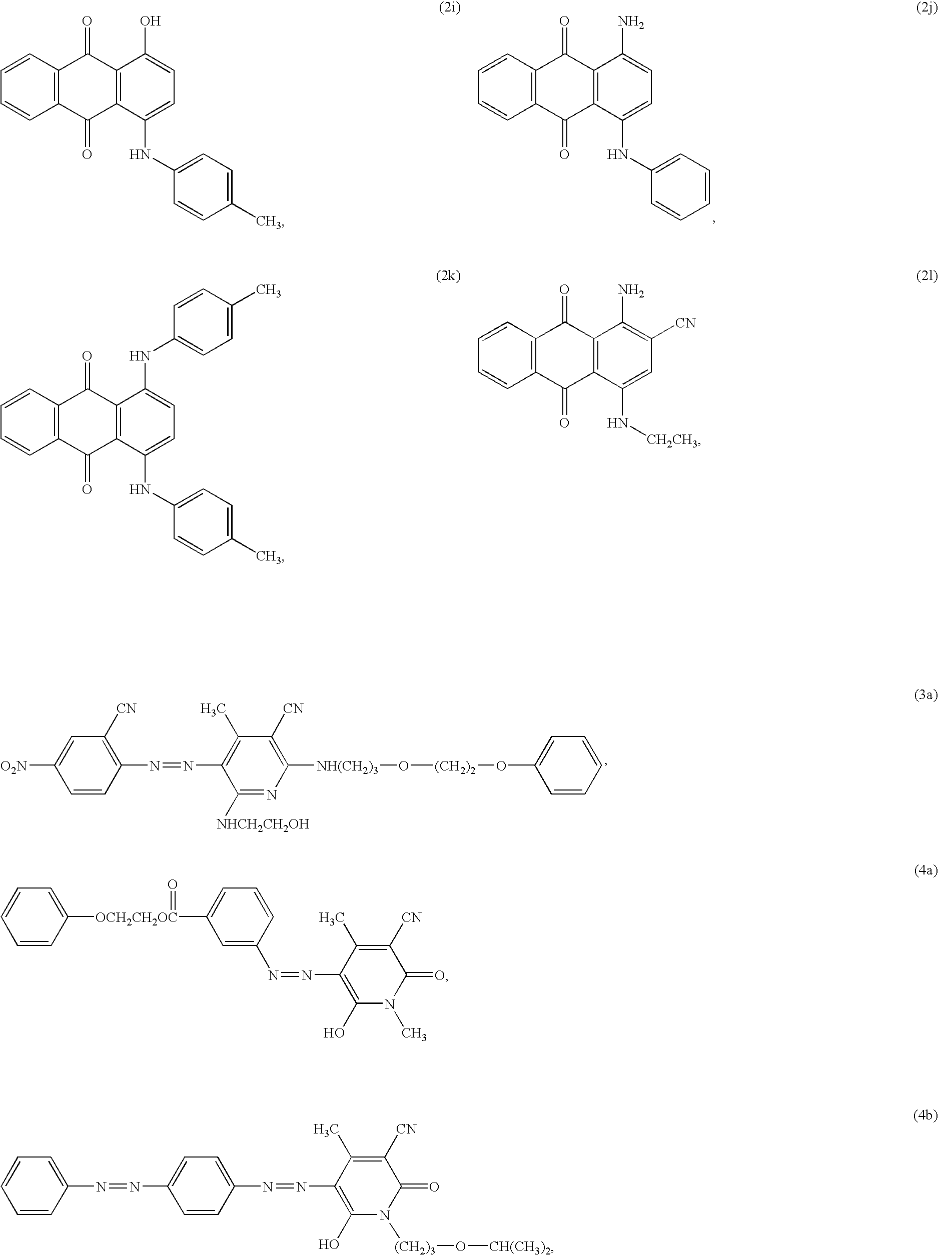

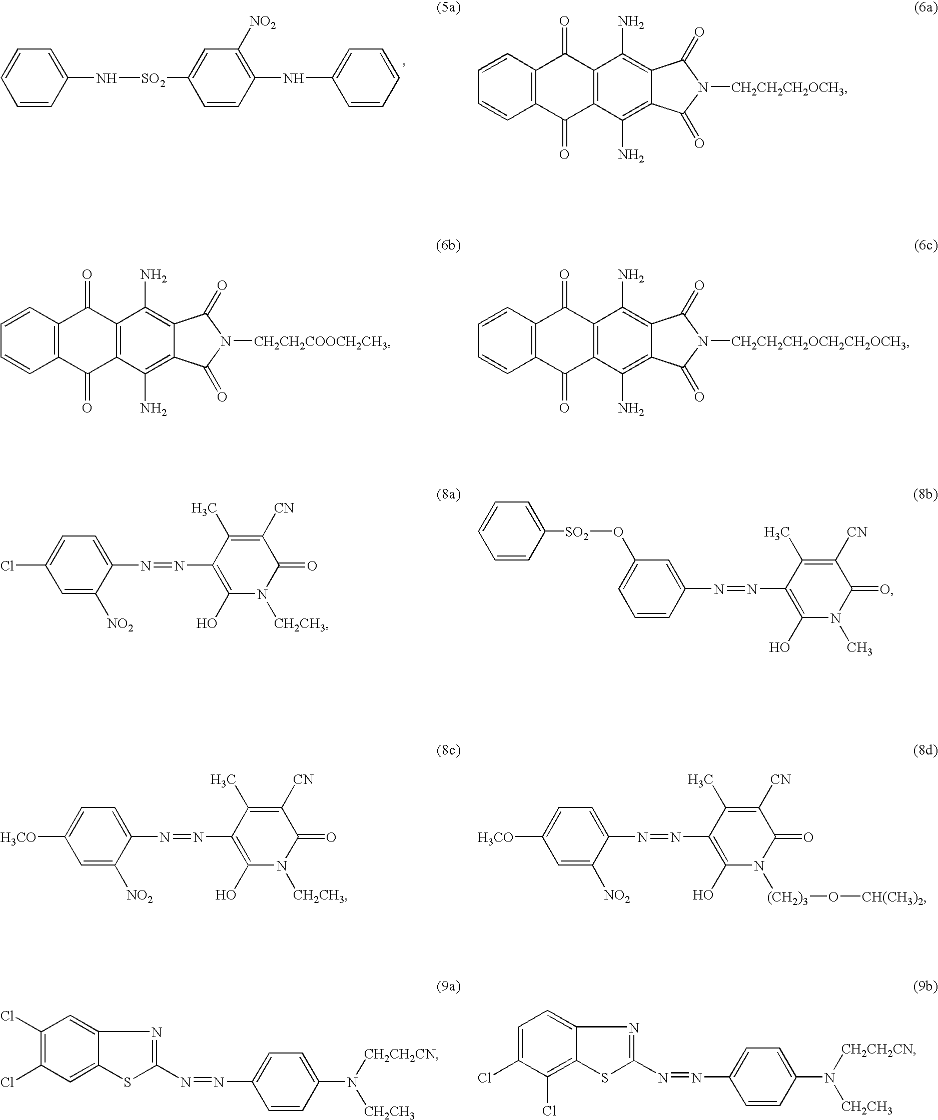

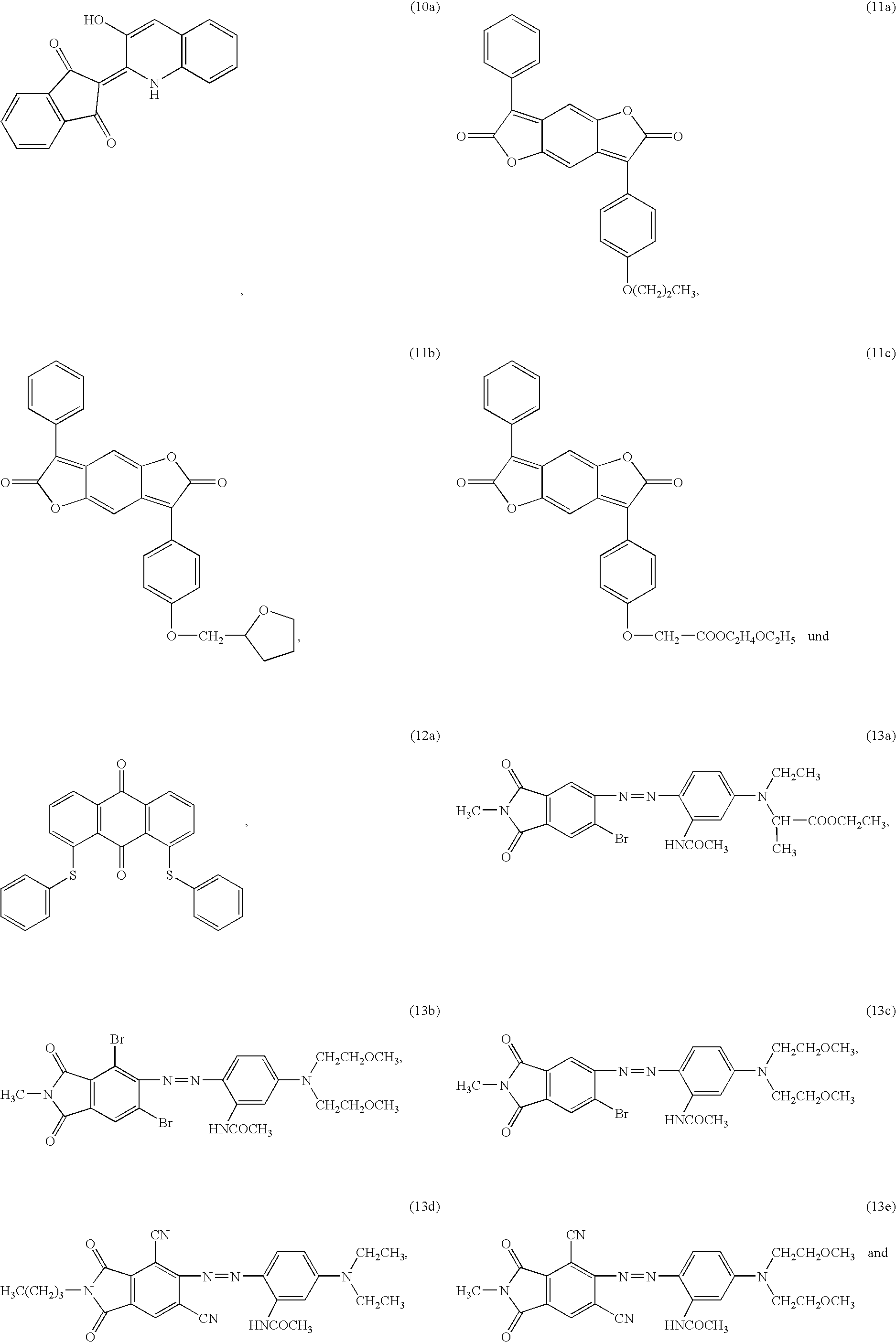

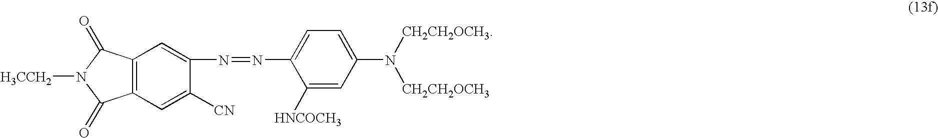

The disperse dyes used in accordance with the present invention may be used as single compounds or as a mixture of two or more dyes.

Preferred are the disperse dyes of formulae (1c), (1d), (1e), (1f), (1g), (1h), (1i), (1j), (1k), (1l), (2f), (2h), (2g), (2i), (2j), (2k), (2l), (4a), (6b), (8a), (8b), (8c), (8d), (10a), (11b), (13a), (13b), (13c), (13d), (13e) and (13f), in particular the dyes of formulae (1c), (2f), (2h), (2g), (2i), (2j), (2k), (2l), (8a) and (10a).

The disperse dyes of formulae (1) to (13) are known or can be obtained analogously to known compounds, e.g. by customary diazotisation, coupling, addition and condensation reactions.

Within the inks of the invention the disperse dyes are advantageously in a finely dispersed form. For this purpose the disperse dyes are milled to an average particle size of between 0.1 and 10 microns, preferably between 1 and 5 microns and, with particular preference, between 0.5 and 2 microns. Milling can be carried out in the presence of dispersants. For example, the dried disperse dye is milled with a dispersant or kneaded in paste form with a dispersant and, if desired, is dried under reduced pressure or by spraying. The resulting preparations can be used to prepare the inks of the invention by addition of water and, if desired, of further auxiliaries.

Suitable dispersants are, for example, anionic dispersants from the group (aa) acidic esters or their salts of alkylene oxide adducts of the formula

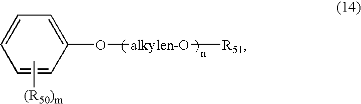

in which
R₅₀ is C₁-C₁₂alkyl, aryl or aralkyl, “alkylen” is the ethylene radical or propylene radical,
R₅₁ is the acid radical of an inorganic, oxygen-containing acid, such as sulfuric or, preferably, phosphoric acid, or else the radical of an organic acid, and
m is from 1 to 4 and n is from 4 to 50,
(ab) polystyrenesulfonates,
(ac) fatty acid taurides,
(ad) alkylated diphenyl oxide mono- or disulfonates,
(ae) sulfonates of polycarboxylic esters,
(af) an adduct of from 1 to 60, preferably from 2 to 30, mol of ethylene oxide and/or propylene oxide with fatty amines, fatty amides, fatty acids or fatty alcohols each having 8 to 22 carbon atoms or with trihydric to hexahydric alkanols having 3 to 6 carbon atoms, the said adduct being converted into an acidic ester with an organic dicarboxylic acid or with an inorganic polybasic acid,
(ag) lignin sulfonates,
(ah) naphthalenesulfonates, and
(ai) formaldehyde condensates.

As lignin sulfonates (ag) use is made primarily of those lignin sulfonates, or their alkali metal salts, whose content of sulfo groups does not exceed 25% by weight. Preferred lignin sulfonates are those having a content of from 5 to 15% by weight of sulfo groups.

Examples of suitable formaldehyde condensates (ai) are condensates of lignin sulfonates and/or phenol and formaldehyde, condensates of formaldehyde with aromatic sulfonic acids, such as condensates of ditolyl ether sulfonates and formaldehyde, condensates of naphthalenesulfonic acid with formaldehyde and/or of naphthol- or naphthylaminosulfonic acids with formaldehyde, condensates of phenolsulfonic acids and/or sulfonated dihydroxydiphenyl sulfone and phenols or cresols with formaldehyde and/or urea, and condensates of diphenyl oxide disulfonic acid derivatives with formaldehyde.

Preferred products (ai) are
condensates of ditolyl ether sulfonates and formaldehyde, as described for example in U.S. Pat. No. 4,386,037,
condensates of phenol and formaldehyde with lignin sulfonates, as described for example in U.S. Pat. No. 3,931,072,
condensates of 2-naphthol-6-sulfonic acid, cresol, sodium bisulfite and formaldehyde [cf. FIAT Report 1013 (1946)], and
condensates of diphenyl derivatives and formaldehyde, as described for example in U.S. Pat. No. 4,202,838.

A particularly preferred compound (ai) is the compound of the formula

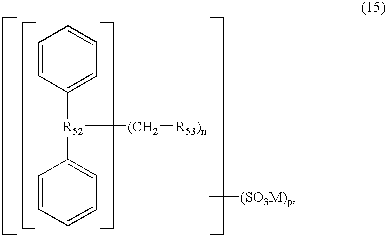

in which
R₅₂ is a direct bond or oxygen,
R₅₃ is the radical of an aromatic compound and is attached to the methylene group by a ring carbon atom,
M is hydrogen or a salt-forming cation, such as an alkali metal, alkaline earth metal or ammonium, and
n and p independently of one another are a number from 1 to 4.

A very particularly preferred compound (ai) is a compound based on the sulfonated condensate of a chloromethylbiphenyl isomer mixture and naphthalene, of the formula

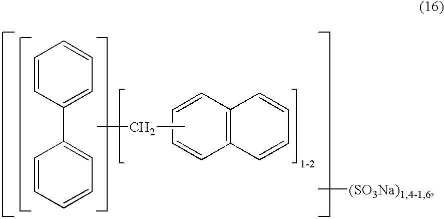

in which (SO₃Na)_{1,4-1,6} denotes an average degree of sulfonation of from 1.4 to 1.6.

The above dispersants are known or can be prepared in analogy to known compounds by widely known processes.

The inks applied in accordance with the present invention may contain anionic copolymers, in particular, those based on acrylic, methacrylic or maleic acid. Among these, preference is given to those obtainable by polymerization of acrylic and/or methacrylic acid and one or more copolymerizable monomers selected from the group consisting of maleic acid, N-vinylformamide, N-vinylacetamide, allylamine and diallylamine derivatives, N-vinylpyrrolidone, N-vinyl-N-methylformamide, N-vinyl-N-methylacetamide, N-vinyl-N-ethylacetamide, vinyl acetate, vinyl propionate, acrylonitrile, styrene, methacrylonitrile, acrylamide, methacrylamide and N-mono/N,N-di-C₁-C₁₀ alkyl(meth)acrylamide.

Particularly preferred anionic copolymers are those obtainable by copolymerization of acrylic or methacrylic acid and styrene.

Very particular preference is given to acrylic and methacrylic acid-styrene copolymers having a molecular weight of from 3000 to 16 000, in particular from 3000 to 10 000.

The inks applied in accordance with the present invention may contain nonionic block polymers, in particular, alkylene oxide condensates, such as adducts of ethylene oxide with polypropylene oxide (known as EO-PO block polymers) and adducts of propylene oxide with polyethylene oxide (known as reverse EO-PO block polymers), and block polymers obtainable by adding styrene onto polypropylene oxide and/or polyethylene oxide.

Preference is given to ethylene-propylene oxide block polymers having molecular weights of between 2000 and 20 000, in particular between 8000 and 16 000, and an ethylene oxide content in the total molecule of from 30 to 80%, in particular from 60 to 80%.

Preferred inks for the process of the invention are those comprising anionic copolymer and nonionic block polymer or anionic copolymer and dispersant or nonionic block polymer and dispersant.

Particularly preferred inks are those comprising anionic copolymer, nonionic block polymer and dispersant.

Glycerol is used in an amount, for example, of from 5 to 60% by weight, preferably from 5 to 50% by weight and especially from 5 to 35% by weight based on the total weight of the ink. As a lower limit, a limit of 10% by weight, preferably 12% by weight and especially 15% by weight, is preferred. In a particular preferred embodiment of the present invention glycerol is used in an amount of from 12 to 60% by weight, preferably from 15 to 50% by weight based on the total weight of the ink.

Glycerol is used solely, although alternatively, glycerol may be used in combination with one or more organic solvents. Further organic solvents which may be used in combination with glycerol are water-miscible organic solvents such as C₁-C₄alcohols, e.g. methanol, ethanol, n-propanol, isopropanol, n-butanol, sec-butanol, tert-butanol or isobutanol; amides, e.g. dimethylformamide or dimethyl acetamide; ketones or ketone alcohols, e.g. acetone, methyl isobutyl ketone, diacetone alcohol; ethers, e.g. tetrahydrofuran or dioxane; nitrogen-containing heterocyclic compounds, e.g. N-methyl-2-pyrrolidone or 1,3-dimethyl-2-imidazolidone; polyalkylene glycols, e.g. polyethylene glycol or polypropylene glycol;

C₂-C₆alkylene glycols and thioglycols, e.g. ethylene glycol, diethylene glycol, triethylene glycol, propylene glycol, dipropylene glycol, tripropylene glycol, butylene glycol, 1,5-pentanediol, thiodiglycol, hexylene glycol, tetraethylene glycol or diethylene glycol monobutyl ether; further polyols, e.g. 1,2,6-hexanetriol; and C₁-C₄alkyl ethers of polyhydric alcohols, e.g. 2-methoxyethanol, 1-methoxypropanol, 2-(2-methoxyethoxy)ethanol, 2-(2-ethoxyethoxy)-ethanol, 2-[2-(2-methoxyethoxy)ethoxy]-ethanol or 2-[2-(2-ethoxyethoxy)ethoxy]-ethanol; preferably diethylene glycol or dipropylene glycol, in particular dipropylene glycol, customarily in an amount of from 2 to 35% by weight, preferably from 5 to 25% by weight and especially from 10 to 25% by weight based on the total weight of the ink.

In a preferred embodiment of the present invention glycerol is used in combination with diethylene glycol or dipropylene glycol, in particular dipropylene glycol, in a ratio, for example, of from 1:5 to 10:1 preferably 1:1 to 6:1 and especially 1:1 to 2:1. In an interesting embodiment of the present invention from 10 to 35% by weight of glycerol are used in combination with dipropylene glycol in an amount of from 10 to 25% by weight, each based on the total weight of the ink.

In addition to the components mentioned above, the ink in accordance with the inventive process can contain, as required, various additives such as a surfactants, humectants, viscosity adjusting agents, buffers, antifoam agents, or preservatives, substances that inhibit the growth of fungi and/or bacteria, etc.

As preservatives there come into consideration formaldehyde-releasing agents, e.g. paraformaldehyde and trioxane, especially aqueous, for example 30 to 40% by weight formaldehyde solutions, imidazole compounds, e.g. 2-(4-thiazolyl)benzimidazole, thiazole compounds, e.g. 1,2-benzisothiazolin-3-one or 2-n-octyl-isothiazolin-3-one, iodine compounds, nitriles, phenols, haloalkylthio compounds and pyridine derivatives, especially 1,2-benzisothiazolin-3-one or 2-n-octyl-isothiazolin-3-one. Such additives are usually used in amounts of from 0.01 to 1% by weight, based on the total weight of the ink. As an example for a broad spectrum biocide for the preservation against spoilage from bacteria, yeasts and fungi a 20% by weight solution of 1,2-benzisothiazolin-3one in dipropylene glycol (Proxel™ GXL) can be used.

The inks may comprise further ingredients such as fluorinated polymers or telomers for example polyethoxy perfluoro alcohols (Forafac® or Zonyl® products) in an amount of from 0.01 to 1% by weight based on the total weight of the ink.

The inks may comprise thickeners of natural or synthetic origin inter alia for the purpose of adjusting the viscosity.

Examples of thickeners that may be mentioned include commercially available alginate thickeners, starch ethers or locust bean flour ethers, especially sodium alginate on its own or in admixture with modified cellulose, e.g. methylcellulose, ethylcellulose, carboxymethylcellulose, hydroxyethylcellulose, methylhydroxyethylcellulose, hydroxypropyl cellulose or hydroxypropyl methylcellulose, especially with preferably from 20 to 25% by weight carboxymethylcellulose. Synthetic thickeners that may be mentioned are, for example, those based on poly(meth)acrylic acids, poly(meth)acrylamides or polyvinyl pyrrolidones.

The inks comprise such thickeners, for example, in an amount of from 0.01 to 2% by weight, especially from 0.01 to 1.2% by weight and more especially from 0.02 to 1% by weight, based on the total weight of the ink.

With or without such viscosity adjusting agent, the viscosity of the ink is adjusted to be from 6 to 14 mPa·s at 25° C., especially from 7 to 12 mPa s at 25° C. and more especially from 8 to 11 mPa s at 25° C.

Unless otherwise indicated, numbers expressing the viscosity of the inks applied in accordance with the present invention are measured by a Brookfield and a Physica Rheolab MC 10 viscosimeter.

The inks may also comprise buffer substances, e.g. borax, borates, phosphates, poly-phosphates or citrates. Examples that may be mentioned include borax, sodium borate, sodium tetraborate, sodium dihydrogen phosphate, disodium hydrogen phosphate, sodium tripoly-phosphate, sodium pentapolyphosphate and sodium citrate. They are used especially in amounts of from 0.1 to 3% by weight, preferably from 0.1 to 1% by weight, based on the total weight of the ink, in order to establish a pH value, for example, of from 4 to 10, especially from 5 to 8.

Suitable surfactants include commercially available anionic or non-ionic surfactants. Betaine monohydrate may be mentioned as an example of a redispersant. As humectants in the inks according to the invention there come into consideration, for example, urea or sodium lactate (advantageously in the form of a 50% to 60% aqueous solution).

It is preferred that the surface tension of the ink is adjusted to range from 20 to 50 dyne/cm at 25° C., especially from 20 to 35 dyne/cm at 25° C. and more especially from 25 to 30 dyne/cm at 25° C.

Furthermore it is preferred that the conductivity of the ink is adjusted to range from 0.1 to 6 mS/cm at 25° C. and especially from 2 to 5 mS/cm at 25° C.

The inks are preferably prepared, for example, by stirring one or more disperse dyes, for example, the dyes of the formulae (1) to (13) with a dispersant/copolymer/block polymer mixture and milling the resulting mixture in a wet mill to a defined degree of milling corresponding to an average particle size of from 0.1 to 1.0 μm. Subsequently, the concentrated millbase—with or without the use of, for example, appropriate thickeners, dispersants, copolymers, surfactants, humectants, redispersants, sequestrants and/or preservatives, and also water—is adjusted to the desired concentration. To remove any coarse fractions present it is possible with advantage to carry out filtration of the ready-to-use ink through a microsieve of about 1 μm.

It has been found that the inks described above can be advantageously applied to the textile fiber materials by means of an ink-jet printing device provided with at least one ink-jet print head which comprises
a nozzle layer (a) defining a plurality of ejection nozzles,
an ink supply layer (b) which is formed from a porous material having a multitude of small interconnected pores so as to allow passage of ink therethrough, the ink supply layer featuring a plurality of connecting bores (holes) from the rear surface to the front surface, each connecting bore being aligned so as to connect between a corresponding one of the ejection nozzles and
a deflection layer (c), comprising a plurality of transducers related to the connecting bores for ejecting ink droplets out through the nozzles.

The ink-jet print head applied in accordance with the present invention may additionally comprise
an ink cavity layer (d), associated with the rear surface of the ink supply layer (b) having a plurality of apertures, each aperture being positioned to correspond to one of the connecting bores of the ink supply layer so as to at least partially define a corresponding ink cavity.

The ink-jet print head applied in accordance with the present invention comprises a layered structure, a key element of which is the ink supply layer (b) made of a porous material. The ink supply layer (b) is in direct communication with both the ink reservoir and the individual ink cavities of the connecting bores (holes) and/or the individual ink cavities of the ink cavity layer (d), thereby acting as hydraulic linkage between the ink main supply and the individual ink cavities.

The porous material includes, for example, sintered material, most preferably, sintered stainless steel.

The ink cavity layer (d) may be omitted. In this case, the deflection layer directly adjoins the ink supply layer.

The ink-jet print head used in accordance with the present invention is described in detail in U.S. Pat. No. 5,940,099, the disclosure of which is incorporated herein.

The ink-jet print head applied in accordance with the present invention belongs to the category of drop on demand systems, wherein the ink drops are ejected selectively as required.

The transducers are, for example, piezoelectric crystals (piezoelectric type) or thermoelectric elements (thermal bubble jet type), preferably piezoelectric crystals.

The ejection of ink drops using a device according to one embodiment of the present invention is accomplished as follows:

A pressure pulse is imparted to a volume of ink in an ink cavity through the deflection of a thin deflection plate, or diaphragm, located on top of the ink cavity. The plate is deflected downward by the action of a piezoceramic crystal whenever a voltage is applied across its electrodes, one of which is in electrical contact with the usually metallic deflection plate. The pressure pulse created by the downward bending of the deflection plate drives the ink towards and through an outlet, having a convergent nozzle at its outlet end, causing the ejection of a drop of a specific size. When the piezoelectric crystal is de-energized, it returns to its equilibrium position, reducing the pressure in the ink cavity and causing the meniscus at the outlet end to retract. The retracted meniscus generates a capillary force which acts to pull ink from an ink reservoir through the porous material of the ink supply layer (b) into the ink cavity and into the connecting bores (holes) related to the nozzle. The refilling process ends when the meniscus regains its equilibrium position.

The micron grade and the surface area of the porous material which is open for flow into the ink cavity has a crucial impact on the refill time of the ink cavities and hence on the maximum drop ejection rate, or frequency. The ink according to the inventive process moves through the interconnected pores and channels of the ink supply layer (b) with suitable flow resistances in order to realize system performance which allows for high ejection frequencies, for example, 5 to 100 kHz, preferably 10 to 50 kHz and especially 25 to 40 kHz. Moreover the inks cause no clogging of the ejection nozzles. Feathering or blurring and blotting on the cloth is omitted. The inks are storage stable, i.e. no deposition of solid matter is observed in the course of storage.

Further embodiments of suitable ink-jet print head configurations comprising an ink supply layer which is formed from a porous material are described in U.S. Pat. No. 5,940,099, all of which can be used in the process according to the present invention.

In a preferred embodiment of the present invention the ink-jet print head comprises
a nozzle layer (a) defining a plurality of ejection nozzles,
an ink supply layer (b) having a front surface associated with the nozzle layer and a rear surface associated with a cavity layer (d), the ink supply layer being formed with a plurality of connecting bores (holes) from the rear surface to the front surface, each connecting bore being aligned so as to connect between a corresponding one of the ink cavities and a corresponding one of the ejection nozzles, wherein the ink supply layer additionally features (i) a pattern of ink distribution channels formed in the front surface, and (ii) at least one ink inlet bore passing from the rear surface to the front surface and configured so as to be in direct fluid communication with at least part of the pattern of ink distribution channels, the pattern of ink distribution channels and the at least one ink inlet bore together defining part of an ink flow path which passes from the rear surface through the at least one ink inlet bore to the pattern of ink distribution channels on the front surface, and through the porous material to the plurality of ink cavities.
a deflection layer (c), comprising a plurality of transducers related to the connecting bores for ejecting ink droplets out through the nozzles.

The location of ink distribution channels on the front surface ensures that ink flow through the porous material of ink supply layer occurs through the bulk of the layer. Preferably ink distribution channels are distributed over the front surface in such a pattern that each connecting bore is approximately the same distance from its nearest ink distribution channel. In the typical case that the connecting bores define an array on the front surface having two row directions, the pattern of ink distribution channels preferably includes a plurality of channels deployed substantially parallel to one of the row directions and interposed between adjacent rows of the connecting bores. The ink flow path is particularly effective for providing a sufficient and generally uniform ink supply to the porous layer across an entire array of ink cavities.

The ink-jet print head used in accordance with the present invention is a multi-nozzle print head, the individual nozzles of which are advantageously arranged as an array made up of horizontal rows which are horizontally staggered, or skewed, with respect to one another, comprising, for example, 512 nozzles staggered in a 32×16 array.

The ink-jet print head used in accordance with the preferred embodiment of the present invention is described in detail in U.S. Pat. No. 6,439,702, the disclosure of which is incorporated herein.

Further embodiments of suitable ink-jet print head configurations comprising an ink supply layer which is formed from a porous material are described in U.S. Pat. No. 6,439,702, all of which can be used in the process according to the present invention.

The ink-jet printing device used in accordance with the present invention comprises at least one of the ink-jet print heads described above. Preferably, the printing device uses at least 3 process colors, for example 3, 4, 5 or 6 process colors, preferably 6 process colors, wherein each color is processed with at least one print head, for example 1, 2, 3, 4, 5, 6 or 7 printing heads, preferably 7 printing heads.

The present invention allows textile fiber materials to be printed with a speed of at least 50 m²/h, preferably in the range of 100 to 250 m²/h, especially 150 to 250 m²/h.

The ink used in accordance with the invention can be applied to a variety of types of fibre material, such as wool, silk, cellulose, polyvinyl, polyacrylonitrile, polyamide, aramid, polypropylene, polyester or polyurethane.

Preference is given to polyester-containing fibre materials. Suitable polyester-containing fibre materials are those consisting wholly or partly of polyester. Examples are cellulose ester fibres, such as secondary cellulose acetate and cellulose triacetate fibres, and especially linear polyester fibres with or without acid modification, which are obtained, for example, by condensation of terephthalic acid with ethylene glycol or of isophthalic acid or terephthalic acid with 1,4-bis(hydroxymethyl)cyclohexane, and also fibres made from copolymers of terephthalic and isophthalic acid with ethylene glycol. Suitability extends to polyester-containing mixed-fibre materials; in other words, to blends of polyester with other fibres.

After printing, the fibre material is advantageously dried, preferably at temperatures of up to 150° C., especially from 80 to 120° C., and then subjected to a heat treatment process in order to complete the print, that is to say to fix the dye, where required.

The subsequent fixing of the fibre material takes place in general by means of dry heat (thermofixing) or by means of superheated steam under atmospheric pressure (HT fixing). Fixing is carried out under the following conditions:
Thermofixing: from 1 to 2 minutes at from 190 to 230° C.;
HT fixing: from 4 to 9 minutes at from 170 to 190° C.

The heat treatment can be carried out, for example, by means of a hot batch process, a thermosol process or, preferably, by means of a steaming process.

In the case of the steaming process the printed fibre material is subjected, for example, to treatment in a steamer with steam which is optionally superheated, advantageously at a temperature of from 95 to 180° C., more especially in saturated steam.

Subsequently the printed fibre material is generally washed off with water in customary manner in order to remove unfixed dye.

Using the printing processes indicated above it is possible to print fibrous materials either in a single shade or in a variety of shades. When the printing is in one shade, the fibrous material can be printed over the entire surface or with a pattern. The use of a single ink is, of course, sufficient for that purpose, but the desired shade can also be created by printing with a plurality of inks of different shades. When the fibrous material is to receive a print having a plurality of different shades, the fibrous material can either be printed with a plurality of inks that each have the desired shade or printed in such a manner that the shade in question is created (for example by printing the fibrous material with inks of different shades one on top of another, thus producing the required shade).

It is to be understood that the scope of the present invention encompasses an embodiment according to which a transfer material, for example, paper, is printed with the inks described above by means of the ink-jet print head or the device comprising the ink-jet print head described above. The printed face of the transfer material is then brought into contact with the textile fiber material. Upon the application of pressure and heat the print is transferred from the transfer material to the textile fiber. The transfer process is known in the art as thermal transfer printing process. Someone of ordinary skill is well aware of the conditions for thermal transfer printing.

The prints produced are distinguished especially by a high tinctorial strength and a high color brilliance as well as by good light-fastness and wet-fastness properties.

The present invention relates also to an aqueous ink comprising

(I) at least one disperse dye selected from the group of dyes of the formulae (1) to (13) as given above,
(II) from 10 to 35% by weight of glycerol based on the total weight of the ink, and
(III) from 10 to 25% by weight of dipropylene glycol based on the total weight of the ink,
said ink having a viscosity from 5 to 20 mPa s at 25° C., wherein
the variables have the meanings and preferences as given above.

The inks according to the present invention may be used in an ink-jet printing process for printing on different kinds of substrates, such as paper, films of plastic or textile fiber materials. In particular the inks are used in the process according to the present invention.

The following Examples serve to illustrate the invention. Unless otherwise indicated, the temperatures are given in degrees Celsius, parts are parts by weight and percentages relate to percent by weight. Parts by weight relate to parts by volume in a ratio of kilograms to litres.

### EXAMPLE 1

2.2 parts by weight of the disperse dye of the formula (10a)
are stirred with
0.3 parts by weight of a dispersant based on a sulfonated condensate of chloromethylbiphenyl isomer mixture and naphthalene and
3.0 parts by weight of an anionic copolymer of acrylic acid and styrene
and the mixture is then milled in a wet mill to an average particle size of from 0.1 to 1.0 μm.

Thereafter the ink, by addition with thorough stirring of

1.0 parts by weight of a commercial surfactant,
3.7 parts by weight of a commercial redispersant,
0.2 parts by weight of a commercial preservative,
28.0 parts by weight of glycerol (85%) and
61.6 parts by weight of water,
is adjusted to a dye content of 2.2 percent by weight to yield a yellow ink.
2.3 parts by weight of the disperse dye of the formula (1c)
are stirred with
0.3 parts by weight of a dispersant based on a sulfonated condensate of chloromethylbiphenyl isomer mixture and naphthalene and
3.0 parts by weight of an anionic copolymer of acrylic acid and styrene
and the mixture is then milled in a wet mill to an average particle size of from 0.1 to 1.0 μm.

Thereafter the ink, by addition with thorough stirring of

1.0 parts by weight of a commercial surfactant,
3.7 parts by weight of a commercial redispersant,
0.2 parts by weight of a commercial preservative,
26.0 parts by weight of glycerol (85%) and
63.5 parts by weight of water,
is adjusted to a dye content of 2.3 percent by weight to yield an orange ink.
1.2 parts by weight of the disperse dye of the formula (2g) and
2.2 parts by weight of the disperse dye of the formula (2f)
are stirred with
1.0 parts by weight of a dispersant based on a sulfonated condensate of chloromethylbiphenyl isomer mixture and naphthalene
and the mixture is then milled in a wet mill to an average particle size of from 0.1 to 1.0 μm.

Thereafter the ink, by addition with thorough stirring of

22.0 parts by weight of glycerol (85%),
6.0 parts by weight of diethylene glycol,
3.0 parts by weight of betaine monohydrate,
0.1 parts by weight of N-hydroxymethylchloroacetamide and
64.5 parts by weight of water,
is adjusted to a total dye content of 3.4 percent by weight to yield a red ink.
3 parts by weight of the disperse dye of the formula (2i)
are stirred with
2.0 parts by weight of a dispersant based on a sulfonated condensate of chloromethylbiphenyl isomer mixture and naphthalene and
6.5 parts by weight of an anionic copolymer of acrylic acid and styrene (®Narlex DX2020 from National Starch & Chemical),
and the mixture is then milled in a wet mill to an average particle size of from 0.1 to 1.0 μm.

Thereafter the ink, by addition with thorough stirring of

20.0 parts by weight of glycerol (85%),
5.0 parts by weight of diethylene glycol,
3.0 parts by weight of betaine monohydrate,
0.1 parts by weight of N-hydroxymethylchloroacetamide and
60.4 parts by weight of water,
is adjusted to a dye content of 3 percent by weight to yield a blue ink.
3.2 parts by weight of the disperse dye of the formula (2h)
are stirred with
0.3 parts by weight of a dispersant based on a sulfonated condensate of chloromethylbiphenyl isomer mixture and naphthalene and
3.0 parts by weight of an anionic copolymer of acrylic acid and styrene
and the mixture is then milled in a wet mill to an average particle size of from 0.1 to 1.0 μm.

Thereafter the ink, by addition with thorough stirring of

1.0 parts by weight of a commercial surfactant,
3.7 parts by weight of a commercial redispersant,
0.2 parts by weight of a commercial preservative,
28.0 parts by weight of glycerol (85%) and
60.6 parts by weight of water,
is adjusted to a dye content of 3.2 percent by weight to yield a turquoise ink.
0.6 parts by weight of the disperse dye of the formula (1c),
0.9 parts by weight of the disperse dye of the formula (2h),
1.4 parts by weight of the disperse dye of the formula (2i),
1.4 parts by weight of the disperse dye of the formula (2j),
0.4 parts by weight of the disperse dye of the formula (10a)
are stirred with
0.3 parts by weight of a dispersant based on a sulfonated condensate of chloromethylbiphenyl isomer mixture and naphthalene and
3.0 parts by weight of an anionic copolymer of acrylic acid and styrene
and the mixture is then milled in a wet mill to an average particle size of from 0.1 to 1.0 μm.

Thereafter the ink, by addition with thorough stirring of

1.0 parts by weight of a commercial surfactant,
3.7 parts by weight of a commercial redispersant,
0.2 part by weight of a commercial preservative,
26.0 parts by weight of glycerol (85%) and
61.1 parts by weight of water,
is adjusted to a total dye content of 4.7 percent by weight to yield a black ink.

The inks prepared as in Example 1 (yellow, orange, red, blue, turquoise and black) are printed on a polyester fabric using an industrial piezoelectric drop on demand ink-jet printing device (Reggiani DReAM) at a speed of 150 m²/h. The device processes 6 colors (6 inks), wherein each process color is printed with 6 print heads (Aprion). The print is dried on line with an integrated hot air dryer at 100° C. and is fixed in superheated steam at 180° C. for 8 minutes. The result is a multicolour print having good all-round fastness properties, especially wetfastness and lightfastness.

A bright multicolour print having good all-round fastness properties, especially wetfastness and lightfastness, is likewise obtained if the dried print is fixed with hot air at 200° C. for 1 minute.

### EXAMPLE 2

Example 1 is repeated, but using as the red ink an ink, which is prepared as follows:

3.5 parts by weight of the disperse dye of the formula (2g)
are stirred with
1.0 part by weight of a dispersant based on a sulfonated condensate of chloromethylbiphenyl isomer mixture and naphthalene
and the mixture is then milled in a wet mill to an average particle size of from 0.1 to 1.0 μm.

Thereafter the ink, by addition with thorough stirring of

21.0 parts by weight of 85% glycerol,
7.0 parts by weight of diethylene glycol,
3.0 parts by weight of betaine monohydrate,
0.1 part by weight of N-hydroxymethylchloroacetamide and
64.5 parts by weight of water,
is adjusted to a dye content of 3.5 percent by weight to yield a red ink.

A multi color print having good all-round fastness properties, especially wetfastness and lightfastness, is likewise obtained.

### EXAMPLE 3

Example 1 is repeated, but using as the black ink an ink, which is prepared as follows:

0.5 parts by weight of the disperse dye of the formula (2g),
1.1 parts by weight of the disperse dye of the formula (2i),
1.4 parts by weight of the disperse dye of the formula (2k),
1.4 parts by weight of the disperse dye of the formula (2l),
0.4 parts by weight of the disperse dye of the formula (10a)
are stirred with
0.3 part by weight of a dispersant based on a sulfonated condensate of chloromethylbiphenyl isomer mixture and naphthalene and
3.0 parts by weight of an anionic copolymer of acrylic acid and styrene
and the mixture is then milled in a wet mill to an average particle size of from 0.1 to 1.0 μm.

Thereafter the ink, by addition with thorough stirring of

1.0 part by weight of a commercial surfactant,
3.7 parts by weight of a commercial redispersant,
0.2 part by weight of a commercial preservative,
29.0 parts by weight of glycerol (85%) and
58 parts by weight of water,
is adjusted to a total dye content of 4.8 percent by weight to yield a black ink.

A multi color print having good all-round fastness properties, especially wetfastness and lightfastness, is likewise obtained.

### EXAMPLE 4

1.6 parts by weight of the disperse dye of the formula (10a)
are stirred with
2.0 parts by weight of a dispersant mixture based on lignin sulfonate and an anionic copolymer of acrylic acid and styrene
and the mixture is then milled in a wet mill to an average particle size of from 0.1 to 1.0 μm.

Thereafter the ink, by addition with thorough stirring of

0.1 parts by weight of a commercial preservative,
25.0 parts by weight of glycerol (85%) and
20.0 parts by weight of dipropylene glycol and
51.3 parts by weight of water,
is adjusted to a dye content of 1.6 percent by weight to yield a yellow ink.
3.0 parts by weight of the disperse dye of the formula (1l)
are stirred with
3.0 parts by weight of a dispersant mixture based on lignin sulfonate and an anionic copolymer of acrylic acid and styrene
and the mixture is then milled in a wet mill to an average particle size of from 0.1 to 1.0 μm.

Thereafter the ink, by addition with thorough stirring of

0.1 parts by weight of a commercial preservative,
25.0 parts by weight of glycerol (85%) and
20.0 parts by weight of dipropylene glycol and
48.9 parts by weight of water,
is adjusted to a dye content of 3.0 percent by weight to yield an orange ink.
3.5 parts by weight of the disperse dye of the formula (2g)
are stirred with
4.0 parts by weight of a dispersant mixture based on lignin sulfonate and an anionic copolymer of acrylic acid and styrene
and the mixture is then milled in a wet mill to an average particle size of from 0.1 to 1.0 μm.

Thereafter the ink, by addition with thorough stirring of

0.1 parts by weight of a commercial preservative,
25.0 parts by weight of glycerol (85%) and
20.0 parts by weight of dipropylene glycol and
47.4 parts by weight of water,
is adjusted to a total dye content of 3.5 percent by weight to yield a red ink.
4.0 parts by weight of a mixture of the disperse dyes of formulae (2i) and (2l)
are stirred with
4.0 parts by weight of a dispersant mixture based on lignin sulfonate and an anionic copolymer of acrylic acid and styrene
and the mixture is then milled in a wet mill to an average particle size of from 0.1 to 1.0 μm.

Thereafter the ink, by addition with thorough stirring of

0.1 parts by weight of a commercial preservative,
25.0 parts by weight of glycerol (85%) and
20.0 parts by weight of dipropylene glycol and
46.9 parts by weight of water,
is adjusted to a dye content of 4 percent by weight to yield a blue ink.
3.5 parts by weight of the disperse dye of the formula (2l)
are stirred with
4.0 parts by weight of a dispersant mixture based on lignin sulfonate and an anionic copolymer of acrylic acid and styrene
and the mixture is then milled in a wet mill to an average particle size of from 0.1 to 1.0 μm.

Thereafter the ink, by addition with thorough stirring of

0.1 parts by weight of a commercial preservative,
25.0 parts by weight of glycerol (85%) and
20.0 parts by weight of dipropylene glycol and
47.4 parts by weight of water,
is adjusted to a dye content of 3.5 percent by weight to yield a cyan ink.
4.5 parts by weight of a mixture of the disperse dyes of formulae (2g), (2i), (2l) and (10a)
are stirred with
5.0 parts by weight of a dispersant mixture based on lignin sulfonate and an anionic copolymer of acrylic acid and styrene
and the mixture is then milled in a wet mill to an average particle size of from 0.1 to 1.0 μm.

Thereafter the ink, by addition with thorough stirring of

0.1 parts by weight of a commercial preservative,
25.0 parts by weight of glycerol (85%) and
20.0 parts by weight of dipropylene glycol and
45.4 parts by weight of water,
is adjusted to a total dye content of 4.5 percent by weight to yield a black ink.

The inks prepared as in Example 4 (yellow, orange, red, blue, cyan and black) are printed on a polyester fabric using an industrial piezoelectric drop on demand ink-jet printing device (Reggiani DReAM) at a speed of 150 m²/h. The device processes 6 colors (6 inks), wherein each process color is printed with 6 print heads (Aprion). The print is dried on line with an integrated hot air dryer at 100° C. and is fixed in superheated steam at 180° C. for 8 minutes. The result is a multicolour print having good all-round fastness properties, especially wetfastness and lightfastness.

A bright multicolour print having good all-round fastness properties, especially wetfastness and lightfastness, is likewise obtained if the dried print is fixed with hot air at 200° C. for 1 minute.

What is claimed is:

1. An ink-jet printing process for printing textile fiber materials, wherein
the fiber materials are printed with an aqueous ink comprising
(I) at least one disperse dye, and
(II) glycerol in an amount of 15% to 50% by weight based on the total weight of the ink,
the ink having a viscosity of from 5 to 20 mPa s at 25° C., and wherein
the ink is applied to the fiber material with an ink-jet print head comprising
an ink supply layer receiving ink from an external ink reservoir, said ink supply layer having a first side and a second side and comprising, a porous medium having a plurality of pores therein and a plurality of holes extending therethrough, so as to allow passage of the ink.

2. A process according to claim 1, wherein the disperse dye is a dye of the formula 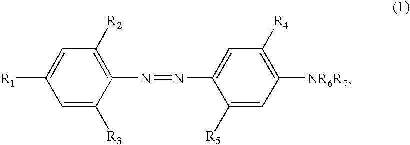
in which
R₁ is halogen, nitro or cyano,
R₂ is hydrogen, halogen, nitro or cyano,
R₃ is hydrogen, halogen or cyano,
R₄ is hydrogen, halogen, C₁-C₄alkyl or C₁-C₄alkoxy,
R₅ is hydrogen, halogen or C₂-C₄alkanoylamino, and
R₆ and R₇ independently of one another are hydrogen, allyl, C₁-C₄alkyl which is unsubstituted or substituted by hydroxy, cyano, C₁-C₄alkoxy, C₁-C₄alkoxy-C₁-C₄alkoxy, C₂-C₄alkanoyloxy, C₁-C₄alkoxycarbonyl, phenyl or phenoxy, 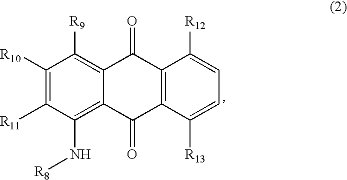
in which
R₈ is hydrogen, C₁-C₄alkyl, phenyl or phenylsulfonyl, the benzene ring in phenyl and phenylsulfonyl being unsubstituted or substituted by C₁-C₄alkyl, sulfo or C₁-C₄alkylsulfonyloxy,
R₉ is hydroxy, amino, N-mono- or N,N-di-C₁-C₄alkylamino, phenylamino, the benzene ring in phenyl being unsubstituted or substituted by C₁-C₄alkyl, C₁-C₄alkoxy, C₂-C₄alkanoylamino or halogen,
R₁₀ is hydrogen, C₁-C₄alkoxy or cyano,
R₁₁ is hydrogen, C₁-C₄alkoxy, phenoxy or the radical —O—C₆H₅—SO₂—NH—(CH₂)₃—O—C₂H₅,
R₁₂ is hydrogen, hydroxy or nitro, and
R₁₃ is hydrogen, hydroxy or nitro, 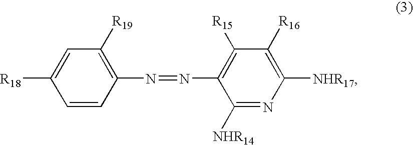
in which
R₁₄ is C₁-C₄alkyl which is unsubstituted or substituted by hydroxy,
R₁₅ is C₁-C₄alkyl,
R₁₆ is cyano,
R₁₇ is the radical of the formula —(CH₂)₃—O—(CH₂)₂—O—C₆H₅,
R₁₈ is halogen, nitro or cyano, and
R₁₉ is hydrogen, halogen, nitro or cyano, 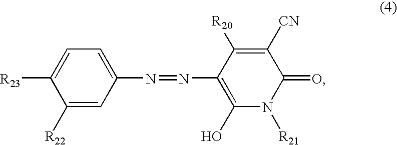
in which
R₂₀ is C₁-C₄alkyl,
R₂₁ is C₁-C₄alkyl which is unsubstituted or substituted by C₁-C₄alkoxy and
R₂₂ is the radical —COOCH₂CH₂OC₆H₅ und R₂₃ is hydrogen or
R₂₂ is hydrogen and R₂₃ is the radical —N═N—C₆H₅, 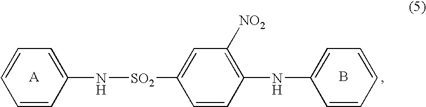
where the rings A and B are unsubstituted or substituted one or more times by halogen, 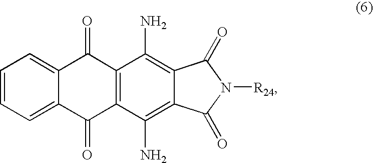
in which
R₂₄ is C₁-C₄alkyl, which is unsubstituted or substituted by hydroxy, C₁-C₄alkoxy, C₁-C₄-alkoxy-C₁-C₄alkoxy, C₂-C₄alkanoyloxy or C₁-C₄alkoxycarbonyl, 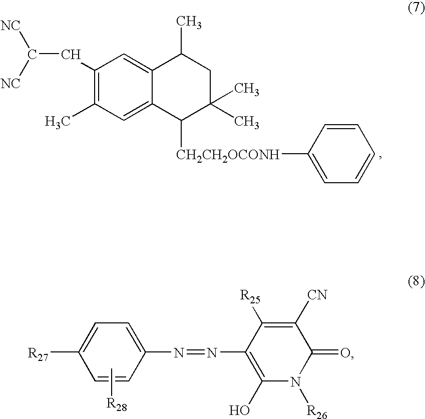
in which
R₂₅ is C₁-C₄alkyl,
R₂₆ is C₁-C₄alkyl, which is unsubstituted or substituted by C₁-C₄alkoxy,
R₂₇ is hydrogen, C₁-C₄alkoxy or halogen, and
R₂₈ is hydrogen, nitro, halogen or phenylsulfonyloxy, 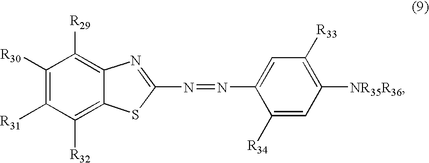
in which
R₂₉, R₃₀, R₃₁ and R₃₂ independently of one another are hydrogen or halogen,
R₃₃ is hydrogen, halogen, C₁-C₄alkyl or C₁-C₄alkoxy,
R₃₄ is hydrogen, halogen or C₂-C₄alkanoylamino, and
R₃₅ and R₃₆ independently of one another are hydrogen, C₁-C₄alkyl, which is unsubstituted or substituted by hydroxy, cyano, acetoxy or phenoxy, 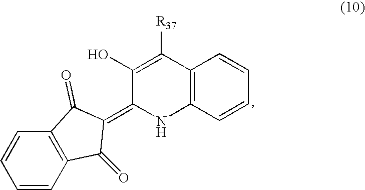
in which
R₃₇ is hydrogen or halogen, 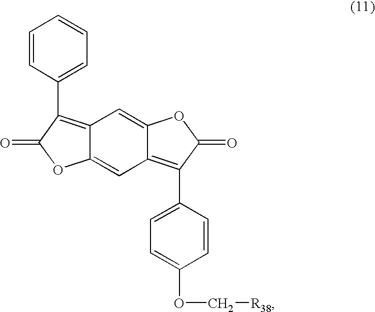
in which
R₃₈ is hydrogen, C₁-C₄alkyl, tetrahydrofuran-2-yl or C₁-C₄alkoxycarbonyl, which is unsubstituted or substituted in the alkyl by C₁-C₄alkoxy, 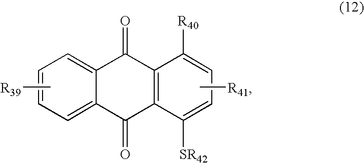
in which
R₃₉ is hydrogen or thiophenyl, which is unsubstituted or substituted in the phenyl by C₁-C₄alkyl or C₁-C₄-alkoxy,
R₄₀ is hydrogen, hydroxy or amino,
R₄₁ is hydrogen, halogen, cyano or thiophenyl, which is unsubstituted or substituted in the phenyl by C₁-C₄alkyl or C₁-C₄-alkoxy, phenoxy or phenyl, and
R₄₂ is phenyl, which is unsubstituted or substituted by halogen, C₁-C₄alkyl or C₁-C₄-alkoxy, or 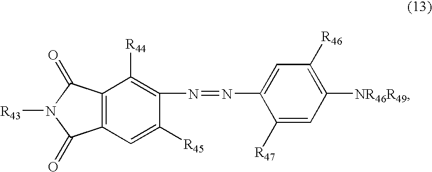
in which
R₄₃ is hydrogen or C₁-C₄alkyl,
R₄₄ and R₄₅ independently of one another are hydrogen, halogen, nitro or cyano,
R₄₆ is hydrogen, halogen, C₁-C₄alkyl or C₁-C₄alkoxy,
R₄₇ is hydrogen, halogen or C₂-C₄alkanoylamino, and
R₄₈ and R₄₉ independently of one another are hydrogen or C₁-C₄alkyl, which is unsubstituted or substituted by hydroxy, cyano, C₁-C₄alkoxy, C₁-C₄alkoxy-C₁-C₄alkoxy, C₂-C₄alkanoyloxy, C₁-C₄alkoxycarbonyl, phenyl or phenoxy.

3. A process according to claim 1, wherein the viscosity of the ink is from 6 to 14 mPa·s at 25° C.

4. A process according to claim 1, wherein the ink further comprises diethylene glycol or dipropylene glycol.

5. A process according to claim 1, wherein printing is performed by means of an ink-jet printing device provided with at least one ink-jet print head which comprises
(a) a nozzle layer defining a plurality of ejection nozzles,
(b) an ink supply layer which is formed from a porous material having a multitude of small interconnected pores so as to allow passage of ink there through, said ink supply layer featuring a plurality of connecting bores from the rear surface to the front surface, each of said connecting bore being aligned so as to connect between a corresponding one of said ejection nozzles and
(c) a deflection layer comprising a plurality of transducers related to said connecting bores for ejecting ink droplets out through the nozzles.

6. A process according to claim 1, wherein printing is performed by means of an ink-jet printing device provided with at least one ink-jet print head which comprises
(a) a nozzle layer defining a plurality of ejection nozzles,
(b) an ink supply layer having a front surface associated with the nozzle layer and a rear surface associated with a cavity layer, said ink supply layer being formed with a plurality of connecting bores from said rear surface to said front surface, each connecting bore being aligned so as to connect between a corresponding one of said ink cavities and a corresponding one of said ejection nozzles, wherein said ink supply layer additionally features
(i) a pattern of ink distribution channels formed in said front surface, and
(ii) at least one ink inlet bore passing from said rear surface to said front surface and configured so as to be in direct fluid communication with at least part of said pattern of ink distribution channels, said pattern of ink distribution channels and said at least one ink inlet bore together defining part of an ink flow path which passes from said rear surface through said at least one ink inlet bore to said pattern of ink distribution channels on said front surface, and through said porous material to said plurality of ink cavities, and
(c) a deflection layer comprising a plurality of transducers related to said connecting bores for ejecting ink droplets out through the nozzles.

7. A process according to claim 5, wherein the plurality of transducers are a piezoelectric element.

8. A process according to claim 1, wherein the fiber material is a polyester-containing fiber material.

9. An aqueous printing ink for an ink-jet printing process, comprising
(I) at least one disperse dye selected from the group of dyes of the formulae (1) to (13) 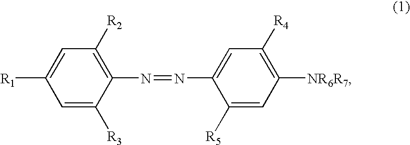
in which
R₁ is halogen, nitro or cyano,
R₂ is hydrogen, halogen, nitro or cyano,
R₃ is hydrogen, halogen or cyano,
R₄ is hydrogen, halogen, C₁-C₄alkyl or C₁-C₄alkoxy,
R₅ is hydrogen, halogen or C₂-C₄alkanoylamino, and
R₆ and R₇ independently of one another are hydrogen, allyl, C₁-C₄alkyl which is unsubstituted or substituted by hydroxy, cyano, C₁-C₄alkoxy, C₁-C₄alkoxy-C₁-C₄alkoxy, C₂-C₄alkanoyloxy, C₁-C₄alkoxycarbonyl, phenyl or phenoxy, 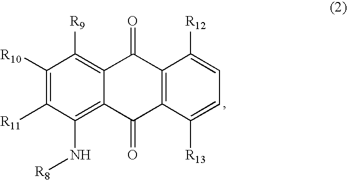
in which
R₈ is hydrogen, C₁-C₄alkyl, phenyl or phenylsulfonyl, the benzene ring in phenyl and phenylsulfonyl being unsubstituted or substituted by C₁-C₄alkyl, sulfo or C₁-C₄alkylsulfonyloxy,
R₉ is hydroxy, amino, N-mono- or N,N-di-C₁-C₄alkylamino, phenylamino, the benzene ring in phenyl being unsubstituted or substituted by C₁-C₄alkyl, C₁-C₄alkoxy, C₂-C₄alkanoylamino or halogen,
R₁₀ is hydrogen, C₁-C₄alkoxy or cyano,
R₁₁ is hydrogen, C₁-C₄alkoxy, phenoxy or the radical —O—C₆H₅—SO₂—NH—(CH₂)₃—O—C₂H₅,
R₁₂ is hydrogen, hydroxy or nitro, and
R₁₃ is hydrogen, hydroxy or nitro, 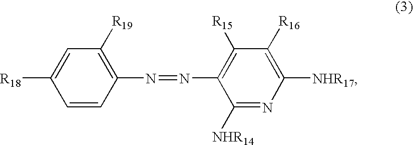
in which
R₁₄ is C₁-C₄alkyl which is unsubstituted or substituted by hydroxy,
R₁₅ is C₁-C₄alkyl,
R₁₆ is cyano,
R₁₇ is the radical of the formula —(CH₂)₃—O—(CH₂)₂—O—C₆H₅,
R₁₈ is halogen, nitro or cyano, and
R₁₉ is hydrogen, halogen, nitro or cyano, 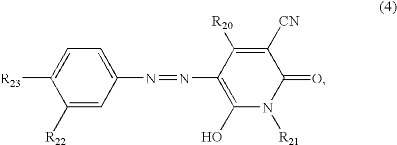
in which
R₂₀ is C₁-C₄alkyl,
R₂₁ is C₁-C₄alkyl which is unsubstituted or substituted by C₁-C₄alkoxy and
R₂₂ is the radical —COOCH₂CH₂OC₆H₅ und R₂₃ is hydrogen or
R₂₂ is hydrogen and R₂₃ is the radical —N═N—C₆H₅, 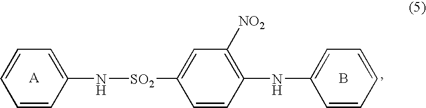
where the rings A and B are unsubstituted or substituted one or more times by halogen, 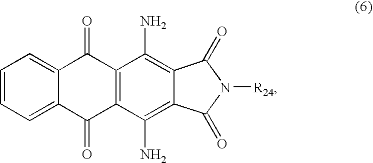
in which
R₂₄ is C₁-C₄alkyl, which is unsubstituted or substituted by hydroxy, C₁-C₄alkoxy, C₁-C₄-alkoxy-C₁-C₄alkoxy, C₂-C₄alkanoyloxy or C₁-C₄alkoxycarbonyl, 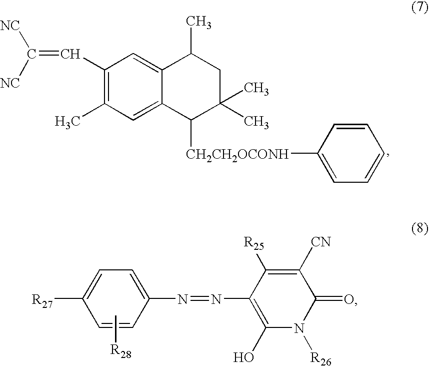
in which
R₂₅ is C₁-C₄alkyl,
R₂₆ is C₁-C₄alkyl, which is unsubstituted or substituted by C₁-C₄alkoxy,
R₂₇ is hydrogen, C₁-C₄alkoxy or halogen, and
R₂₈ is hydrogen, nitro, halogen or phenylsulfonyloxy, 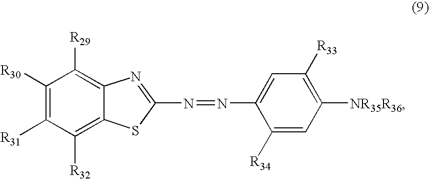
in which
R₂₉, R₃₀, R₃₁ and R₃₂ independently of one another are hydrogen or halogen,
R₃₃ is hydrogen, halogen, C₁-C₄alkyl or C₁-C₄alkoxy,
R₃₄ is hydrogen, halogen or C₂-C₄alkanoylamino, and
R₃₅ and R₃₆ independently of one another are hydrogen, C₁-C₄alkyl, which is unsubstituted or substituted by hydroxy, cyano, acetoxy or phenoxy, 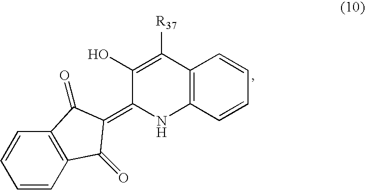
in which
R₃₇ is hydrogen or halogen, 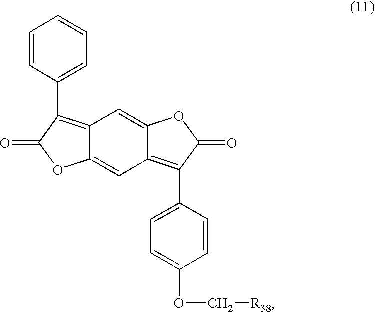
in which
R₃₈ is hydrogen, C₁-C₄alkyl, tetrahydrofuran-2-yl or C₁-C₄alkoxycarbonyl, which is unsubstituted or substituted in the alkyl by C₁-C₄alkoxy, 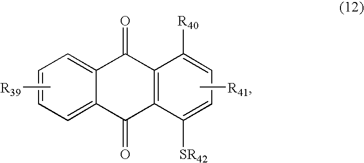
in which
R₃₉ is hydrogen or thiophenyl, which is unsubstituted or substituted in the phenyl by C₁-C₄alkyl or C₁-C₄-alkoxy,
R₄₀ is hydrogen, hydroxy or amino,
R₄₁ is hydrogen, halogen, cyano or thiophenyl, which is unsubstituted or substituted in the phenyl by C₁-C₄alkyl or C₁-C₄-alkoxy, phenoxy or phenyl, and
R₄₂ is phenyl, which is unsubstituted or substituted by halogen, C₁-C₄alkyl or C₁-C₄-alkoxy, or 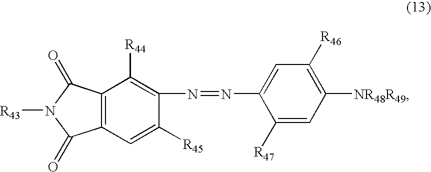
in which
R₄₃ is hydrogen or C₁-C₄alkyl,
R₄₄ and R₄₅ independently of one another are hydrogen, halogen, nitro or cyano,
R₄₆ is hydrogen, halogen, C₁-C₄alkyl or C₁-C₄alkoxy,
R₄₇ is hydrogen, halogen or C₂-C₄alkanoylamino, and
R₄₈ and R₄₉ independently of one another are hydrogen or C₁-C₄alkyl, which is unsubstituted or substituted by hydroxy, cyano, C₁-C₄alkoxy, C₁-C₄alkoxy-C₁-C₄alkoxy, C₂-C₄alkanoyloxy, C₁-C₄alkoxycarbonyl, phenyl or phenoxy,
(II) from 10 to 35% by weight of glycerol based on the total weight of the ink, and
(III) from 10 to 25% by weight of dipropylene glycol based on the total weight of the ink, the ink having a viscosity of from 5 to 20 mPa s at 25° C.
